(19) United States
(12) Patent Application Publication
(10) Pub. No.: US 2020/0321725 A1
(43) Pub. Date: Oct. 8, 2020

(54) Connector

(71) Applicant: Yazaki Corporation, Tokyo (JP)

(72) Inventors: Kazuhide Ikeya, Makinohara-shi (JP); Hikaru Anma, Makinohara-shi (JP); Sho Kasuya, Makinohara-shi (JP)

(73) Assignee: Yazaki Corporation, Tokyo (JP)

(21) Appl. No.: 16/838,634

(22) Filed: Apr. 2, 2020

(30) Foreign Application Priority Data
Apr. 8, 2019 (JP) 2019-073651

(51) Int. Cl. H01R 13/629; H01R 13/627

(52) U.S. Cl. CPC H01R 13/629; H01R 13/6272

(57) ABSTRACT

A connector includes a housing to be fitted to a mating housing. The housing includes an outer peripheral surface exposed to an outside of the connector, the outer peripheral surface including a high-friction surface having a greater surface roughness than a portion of the outer peripheral surface other than the high-friction surface.

### CROSS-REFERENCE TO RELATED APPLICATION

The present application claims priority to Japanese Patent Application No. 2019-073651 filed on Apr. 8, 2019, the entire content of which is incorporated herein by reference.

### TECHNICAL FIELD

The present invention relates to a connector.

### BACKGROUND

A related art connector includes, on an outer peripheral surface of a housing thereof or in an operation portion of a lock arm thereof, a slip preventing portion in which a plurality of convex portions are formed, the plurality of convex portions extending in a direction perpendicular to a direction in which the connector is to be fitted to a mating connector, thereby rendering the connector easy to handle at the time of fitting to and detaching from the mating connector (see, for example, JP2014-153511A and JP2016-110735A).

However, since the plurality of convex portions are formed on the housing of the connector described above, an increase in size of the housing is inevitable, which leads to an increase in size of the connector. Further, when a plurality of concave portions are formed instead of the plurality of convex portions for preventing slips, a thickness of the housing may be reduced, which may lead to a decrease in strength of the housing.

### SUMMARY

Illustrative aspects of the present invention provide a connector easy to handle at the time of fitting and detaching operations and configured to prevent an increase in size and a decrease in strength of the connector.

According to an illustrative aspect of the present invention, a connector includes a housing to be fitted to a mating housing. The housing includes an outer peripheral surface exposed to an outside of the connector, the outer peripheral surface including a high-friction surface having a greater surface roughness than a portion of the outer peripheral surface other than the high-friction surface.

Other aspects and advantages of the invention will be apparent from the following description, the drawings and the claims.

### BRIEF DESCRIPTION OF THE DRAWINGS

FIG. 1 is a perspective view of a male housing and a female housing of a connector according to an embodiment;

FIG. 2 is an exploded perspective view of the female housing;

FIG. 3 is a longitudinal cross-sectional view of the female housing;

FIG. 4 is a side view of the female housing;

FIG. 5 is a perspective view of a female housing according to a modification;

FIGS. 6A and 6B are views illustrating the modification, in which FIG. 6A is a plan view of the female housing, and FIG. 6B is a bottom view of the female housing; and

FIG. 7 is a perspective view of a female housing according to another modification.

### DETAILED DESCRIPTION

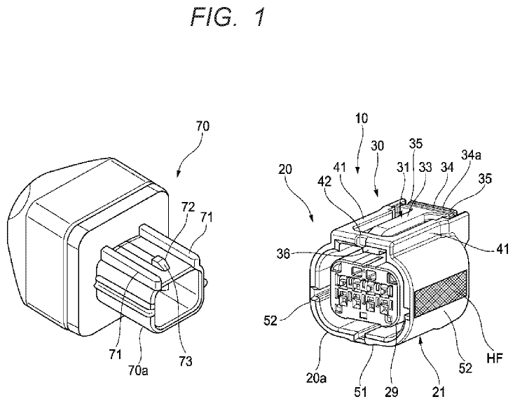

Hereinafter, exemplary embodiments of the present invention will be described in detail with reference to the drawings FIG. 1 is a perspective view of a male housing and a female housing of a connector according to the present embodiment. As illustrated in FIG. 1, a connector 10 according to the present embodiment includes a female housing (housing) 20 that is to be fitted into a male housing (mating housing) 70.

The male housing 70 includes a connection portion 70a. The female housing 20 includes a hood portion 20a. The male housing 70 and the female housing 20 are joined to each other by inserting the connection portion 70a of the male housing 70 into the hood portion 20a of the female housing 20.

The male housing 70 is formed of a synthetic resin and includes the tubular connection portion 70a. A plurality of male terminals (not shown) is provided in the male housing 70, and these male terminals are arranged in the connection portion 70a.

The male housing 70 includes a pair of guide projections 71 and a projection portion 72 on an upper surface of the connection portion 70a. The guide projections 71 are formed along a direction in which the female housing 20 is fitted to the male housing 70, i.e., a direction in which the female housing 20 gets close to the male housing 70 (hereinafter, simply referred to as a fitting direction). The guide projections 71 are spaced apart from each other. The projection portion 72 is formed in the middle of a widthwise direction of the upper surface of the connection portion 70a, between the pair of guide projections 71. The projection portion 72 projects from an upper surface of the connection portion 70a. A guide surface 73 that is gradually inclined upward toward a rear end side of the male housing 70 is formed in the vicinity of a distal end of the connection portion 70a.

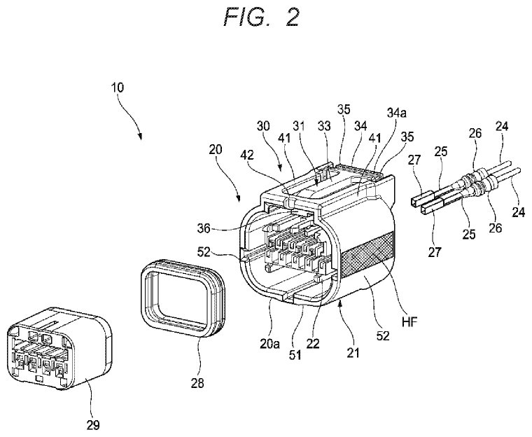

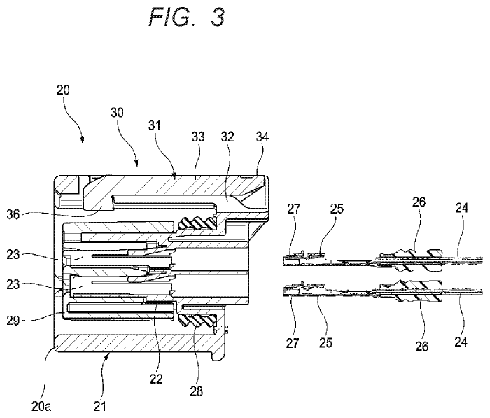

FIG. 2 is an exploded perspective view of the female housing. FIG. 3 is a longitudinal cross-sectional view of the female housing. As illustrated in FIGS. 2 and 3, the female housing 20 includes a housing body 21 having the hood portion 20a formed in a tubular shape, and a fitting portion 22 projects in the housing body 21. The female housing 20 is formed of a synthetic resin, and a plurality of terminal accommodating chambers 23 are formed in the fitting portion 22. A female terminal 25 connected to an end portion of an electric wire 24 is to be accommodated in each of the terminal accommodating chambers 23, and the electric wire 24 is to be drawn out from a rear end of the housing body 21. A seal member 26 attached to the electric wire 24 is to be fitted into the terminal accommodating chamber 23 from a rear end side of the housing body 21. Accordingly, the terminal accommodating chamber 23 of the housing body 21 in which the female terminal 25 is to be accommodated is sealed so that water does not get into the terminal accommodating chamber 23.

The female terminal 25 is formed of, for example, a conductive metal material such as copper or a copper alloy, and is connected to the electric wire 24 by crimping. The female terminal 25 includes an electrical connection portion 27 formed in a tubular shape.

An annular seal member 28 for sealing a portion at which the male housing 70 and the female housing 20 are joined (a joint portion) between the female housing 20 and the male housing 70 from a tip end side (a tip end side of the annular seal member 28 in a front side of the fitting direction) is attached to the fitting portion 22 of the female housing 20. Further, a front holder 29 molded from a synthetic resin is attached to the fitting portion 22. By virtue of the front holder 29 being attached to the fitting portion 22, the female terminal 25 accommodated in the terminal accommodating chamber 23 is prevented from moving toward the fitting direction, i.e., the female terminal 25 is prevented from moving toward a direction in which the female terminal 25 is further inserted into the terminal accommodating chamber 23. Also, the front holder 29 retains the sealing member 28 held on the fitting portion 22.

The housing body 21 of the female housing 20 includes a bottom plate 51 and side plates 52 connected to both side edges of the bottom plate 51, and a lock mechanism portion 30 provided at upper sides of the side plates 52. Accordingly, the housing body 21 is formed into a box shape by the bottom plate 51, the side plates 52, and the lock mechanism portion 30, the box shape being open on a front side in the fitting direction.

The lock mechanism portion 30 includes a lock arm 31. The lock arm 31 includes a pair of support arms 32 and a swing arm 33. The support arms 32 are connected to the housing body 21. The support arms 32 are formed in a cantilever manner having a beam shape extending toward the front side in the fitting direction. The support arms 32 are arranged in parallel and are spaced apart from each other. The swing arm 33 is provided between the pair of support arms 32. The swing arm 33 extends to a rear side in the fitting direction, with an end portion thereof on the front side in the fitting direction being connected to each of the support arms 32. The swing arm 33 includes an operation portion 34 at a rear end portion of the swing arm 33, the rear end portion being opposite to a side where the swing arm 33 is connected to the support arm 32, i.e., the swing arm 33 includes the operation portion 34 at the rear end portion in the fitting direction. The operation portion 34 has an extension portion 35 extending to lateral sides. A locking groove 34a for preventing slips that extends in a direction perpendicular to the fitting direction is formed in the operation portion 34 of the swing arm 33. A lock claw 36 protruding toward a housing body 21, i.e., protruding inward, is formed at a front end of the lock arm 31. The support arm 32 and swing arm 33 are connected at the front end of the lock arm31. In the lock arm 31, the swing arm 33 is swung by the support arm 32 elastically deforming.

The lock mechanism portion 30 includes a pair of protective walls 41. The protective walls 41 are provided adjacent to both sides of the lock arm 31 in a lateral direction, i.e., in a widthwise direction of the lock arm 31. The protective walls 41 laterally surrounds the lock arm 31 and thereby protecting lateral sides of the lock arm 31. In other words, the both sides of the lock arm 31 are surrounded and protected by the protective walls 41. A beam 42 is provided on the front side of the protective walls 41 in the fitting direction. Both lateral ends of the beam 42 are connected to the protective walls 41. The beam 42 is spaced apart from the housing body 21.

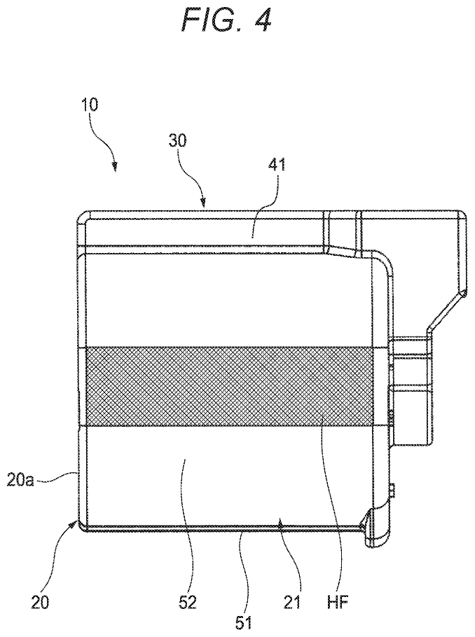

FIG. 4 is a side view of the female housing. As illustrated in FIG. 4, the female housing 20 includes a high-friction surface HF on both side plates 52 of the housing body 21. Each the high-friction surface HF is formed along the fitting direction, at a substantially center position in a height direction of the housing body 21 on a side surface that is an outer surface of the side plate 52.

Surface roughness of the high-friction surface HF is greater than that of portions of the outer peripheral surface of the female housing 20 other than the high-friction surface HF. For example, surface roughness (arithmetic average roughness, Ra) of portions other than the high-friction surface HF on the outer peripheral surface of the female housing 20 is less than Ra50, whereas surface roughness (arithmetic average roughness) of the high-friction surface HF is equal to or greater than Ra100. Further, the high-friction surface HF has a higher static friction coefficient than portions other than the high-friction surface HF on the outer peripheral surface of the female housing 20. In the high-friction surface HF, the static friction coefficient in all directions within a plane direction is increased.

The high-friction surface HF can be formed, for example, by performing blasting, laser irradiation, rasping or the like with respect to a predetermined part where the high-friction surface HF is to be formed on the female housing 20. A coating material that roughens a surface may be applied to the predetermined part where the high-friction surface HF is to be formed, or an adhesive tape having a high-friction surface may be attached. Moreover, the high-friction surface HF may be formed on the female housing 20 by molding the female housing 20 with a mold, a part of the mold underwent a blast processing or the like to form the high-friction surface HF on the female housing 20.

Next, how the female housing 20 of the connector 10 is to be fitted to the male housing 70 will be described.

The fitting portion 22 is fitted to the male housing 70 by bringing the hood portion 20a of the female housing 20 toward the connection portion 70a of the male housing 70. Then, the lock mechanism portion 30 is guided by the guide projection 71 of the male housing 70, and the lock claw 36 of the lock arm 31 of the female housing 20 comes into contact with the guide surface 73 of the projection portion 72 of the male housing 70.

When the female housing 20 is pushed toward to the male housing 70, the lock claw 36 of the lock arm 31 being in contact with the guide surface 73 of the projection portion 72, gets on and starts sliding on the guide surface 73, and the support arm 32 of the lock arm 31 is elastically deformed. Accordingly, the swing arm 33 of the lock arm 31 swings with a front end side of the swing arm 33 having the lock claw 36 is moved in a direction away from the housing body 21.

By further pushing the female housing 20 with respect to the male housing 70, the lock claw 36 proceeds and reaches a position further in the fitting direction than the projection portion 72. When the lock claw 36 is in the position, an inner surface of the lock claw 36, the inner surface extending in the upper-lower direction, faces a surface of the projection portion 72, the surface being opposite to the guide surface 73 and extending in the upper-lower direction. What has happened is, the support arm 32 that has been elastically deformed gets restored, thereby swinging back the swing arm 33, and the lock claw 36 slides over the projection portion 72 toward the front side in the fitting direction and is locked with the projection portion 72. Accordingly, the female housing 20 is fitted to the male housing 70 being locked thereto.

In this fitted state, the connection portion 70a of the male housing 70 contacts the seal member 28 attached to the fitting portion 22 of the female housing 20 in a tight manner, and the portion at which the male housing 70 and the female housing 20 are joined is reliably sealed. Further, in this fitted state, the male terminal is inserted into the electrical connection portion 27 of the female terminal 25, and the female terminal 25 and the male terminal are electrically connected.

In the fitting operation described above, an operator holds both side plates 52 of the housing body 21 of the female housing 20 with fingers and pushes the female housing 20 into the male housing 70. At this time, since the high-friction surface HF having great surface roughness is provided on the side plate 52, the operator can push the female housing 20 into the male housing 70 without their fingers slipping on the side plate 52.

Next, how the female housing 20 is to be detached from the male housing 70 will be described.

To detach the female housing 20 from the male housing 70, the operation portion 34 at the rear end of the swing arm 33 in the lock arm 31 of the female housing 20 is pushed toward the housing body 21.

Then, the swing arm 33 is swung, and the front end side of the lock arm 31 is moved in the direction away from the housing body 21. Accordingly, the lock claw 36 gets away from the housing body 21, the lock claw 36 is released from a locking with the projection portion 72, and the female housing 20 is released from a locked state with the male housing 70.

In this state, the female housing 20 is moved in a direction in which the female housing 20 gets away from the male housing 70. Accordingly, the female housing 20 is detached from the male housing 70, and electrical connection between the female terminal 25 and the male terminal is cut.

In the detaching operation described above, the operator releases the locking of the female housing 20 with respect to the male housing 70 by the lock arm 31, and then holds both side plates 52 of the housing body 21 of the female housing 20 with fingers and pulls the female housing away from the male housing 70. At this time, since the high-friction surface HF having great surface roughness is provided on the side plate 52, the operator can pull the female housing 20 away from the male housing 70 without their fingers slipping on the side plate 52.

As described above, with the connector 10 according to the present embodiment, when fitting the female housing 20 to and detaching the female housing 20 from the male housing 70, slipping of fingers with respect to the female housing 20 can be prevented by bringing fingers holding the female housing 20 into contact with the high-friction surface HF. As compared with a connector in an irregular shape in which a plurality of projections or recesses are formed for preventing slips, it is possible to fit the female housing 20 to and detach the female housing 20 from the male housing 70 more easily while preventing an increase in size or a decrease in strength due to thinning of the connector 10.

In particular, the high-friction surface HF is provided on both side surfaces that are outer surfaces of both side plates 52 of the housing body 21 of the female housing 20. Therefore, by gripping the female housing 20 from the both sides with fingers, the operator can fit the female housing 20 to and detach the female housing 20 from the male housing 70 without having fingers slipping thereon.

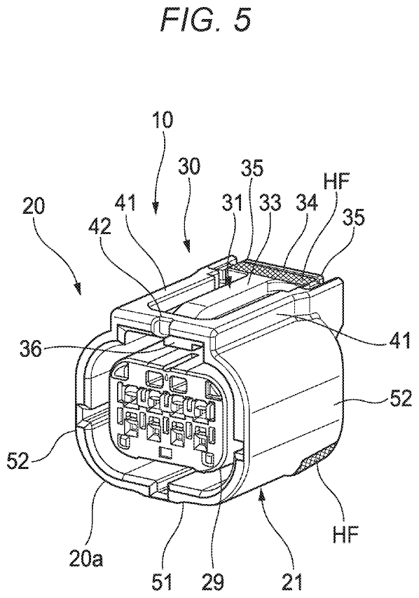

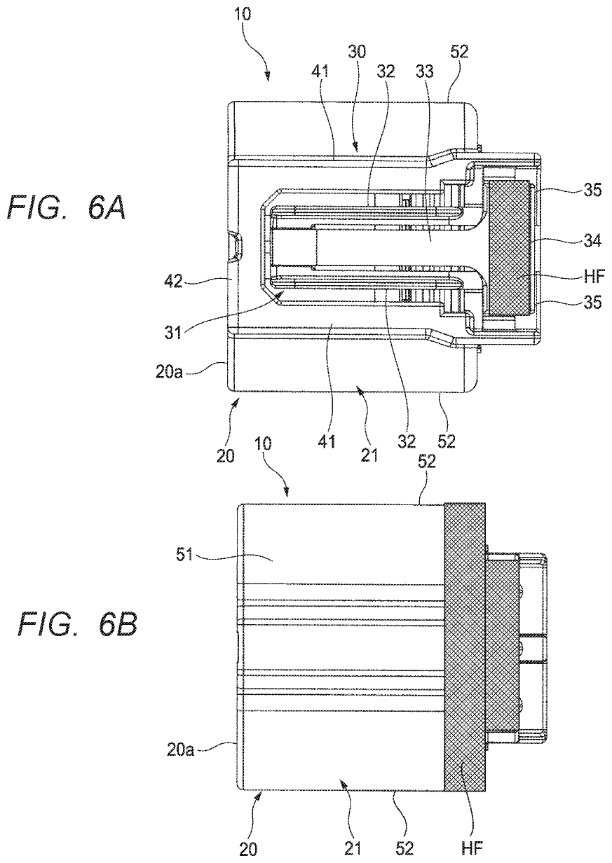

Next, a modification will be described. FIG. 5 is a perspective view of a female housing according to the modification. FIGS. 6A and 6B are views illustrating the modification, in which FIG. 6A is a plan view of the female housing, and FIG. 6B is a bottom view of the female housing. As illustrated in FIG. 5, in the connector 10 according to the modification, the high-friction surface HF is provided on the bottom plate 51 of the housing body 21 and in the lock mechanism portion 30.

As illustrated in FIG. 6A, the high-friction surface HF of the lock mechanism portion 30 is provided along a widthwise direction of the female housing 20 on an upper surface of the operation portion 34 of the swing arm 33 of the lock arm 31. As illustrated in FIG. 6B, the high-friction surface HF of the bottom plate 51 is provided along the widthwise direction in the vicinity of a rear end of the bottom plate 51 in the fitting direction.

In this modification, when the swing arm 33 of the lock arm 31 is swung to release locking, an operator can grip on the operation portion 34 and a lower portion of the housing body 21 without their fingers slipping thereon. Further, even after the release of the locking, the operator can pull the female housing 20 away from the male housing 70 without their fingers slipping on the operation portion 34 and the lower portion of the housing body 21.

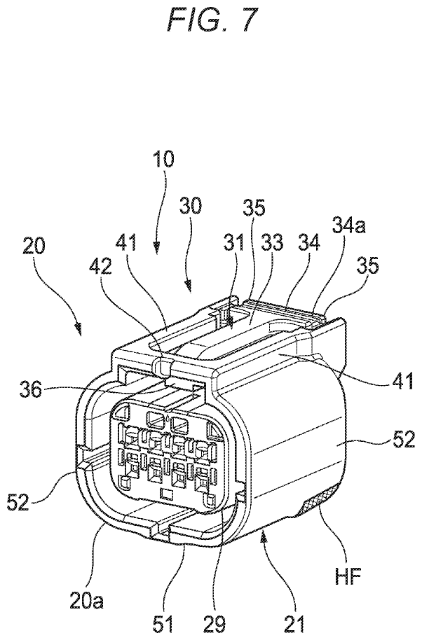

As illustrated in FIG. 7, in another modification, the high-friction surface HF may be provided only on the bottom plate 51, and the operation portion 34 of the lock arm 31 may have the locking groove 34a. Also in this case, the operator can grip on the operation portion 34 and the lower portion of the housing body 21 as well as can pull the female housing 20 away from the male housing 70 without their fingers slipping on the operation portion 34 and the lower portion of the housing body 21.

The high-friction surface HF may be provided on both side plates 52, and may also be provided on the bottom plate 51 and the operation portion 34 of the lock arm 31 at the same time. In this way, the operator can push the female housing 20 into the male housing 70 without their fingers slipping on the side plate 52 in the fitting operation. Further, at the time of releasing locking between the female housing 20 and the male housing 70, and pulling the female housing 20 away from the male housing 70 in the detaching operation, these operations can be carried out without the operators slipping their fingers on the operation portion 34 and the lower portion of the housing body 21.

While the present invention has been described with reference to certain exemplary embodiments thereof, the scope of the present invention is not limited to the exemplary embodiments described above, and it will be understood by those skilled in the art that various changes and modifications may be made therein without departing from the scope of the present invention as defined by the appended claims.

According to an aspect of the embodiments described above, a connector (10) includes a housing (female housing 20) to be fitted to a mating housing (male housing 70). The housing (female housing 20) includes an outer peripheral surface exposed to an outside of the connector (10), the outer peripheral surface comprising a high-friction surface (HF) having a greater surface roughness than a portion of the outer peripheral surface other than the high-friction surface (HF).

According to the connector having the above-described configuration, by holding the housing with fingers at the high-friction surface at the time of fitting the housing to and detaching the housing from the mating housing, slipping of fingers with respect to the housing can be prevented. As compared with a connector with an irregular shape in which a plurality of projections or recesses are formed for preventing slips, it is possible to fit the housing to and detach the housing from the mating housing easily while preventing an increase in size or a decrease in strength due to thinning of the housing.

The high-friction surface (HF) may be provided on each side of the housing (female housing 20).

With this configuration, an operator can fit the housing to and detach the housing from the mating housing without their fingers slipping, by gripping on the housing at the both side surfaces with fingers.

The housing (female housing 20) may include a lock arm (31) provided at a first position on an outer periphery of the housing (female housing 20), the lock arm (31) being configured to engage with and a projection portion (72) of the mating housing (male housing 70) to lock the projection portion (72). The high-friction surface (HF) may be provided at a second position on the outer periphery of the housing (female housing 20), the first position and the second position being opposite to each other on the outer periphery of the housing (female housing 20).

With this configuration, by gripping the housing at the lock arm and the high-friction surface with fingers, the operator can fit the housing to and detach the housing from the mating housing without their fingers slipping on the lock arm and the high-friction surface provided on an opposite side to each other while operating the lock arm.

The high-friction surface (HF) may be provided on the lock arm (31).

With this configuration, the operator can fit the housing to and detach the housing from the mating housing without their fingers slipping on the high-friction surface of the lock arm and the high-friction surface on the side opposite to the lock arm on the housing while operating the lock arm.

What is claimed is:

1. A connector comprising a housing to be fitted to a mating housing,
wherein the housing comprises an outer peripheral surface exposed to an outside of the connector, the outer peripheral surface comprising a high-friction surface having a greater surface roughness than a portion of the outer peripheral surface other than the high-friction surface.

2. The connector according to claim 1,
wherein the high-friction surface is provided on both sides of the housing.

3. The connector according to claim 1,
wherein the housing comprises a lock arm provided at a first position on an outer periphery of the housing, the lock arm being configured to engage with and a projection portion of the mating housing to lock the projection portion, and
wherein the high-friction surface is provided at a second position on the outer periphery of the housing, the first position and the second position being opposite to each other on the outer periphery of the housing.

4. The housing according to claim 3 comprising
the high-friction surface being provided on the lock arm.
